(19) United States
(12) Patent Application Publication
(10) Pub. No.: US 2022/0055479 A1
(43) Pub. Date: Feb. 24, 2022

(54) VEHICULAR HEAD-UP DISPLAY SYSTEM WITH VIRTUAL IMAGES IN DIFFERENT DISTANCES

(71) Applicant: CONSERVE & ASSOCIATES , Inc., TAOYUAN CITY (TW)

(72) Inventors: Zong QIN, TAOYUAN CITY (TW); Shih-Ming LIN, TAOYUAN CITY (TW); Yeah Min LIN, TAOYUAN CITY (TW); Kuang-Tso LUO, TAOYUAN CITY (TW)

(21) Appl. No.: 17/000,949

(22) Filed: Aug. 24, 2020

(51) Int. Cl. B60K 35/00; G02B 27/28

(52) U.S. Cl. CPC B60K 35/00; G02B 27/283; B60K 2370/785; B60K 2370/31; B60K 2370/39; B60K 2370/1529

(57) ABSTRACT

A vehicular head-up display system provides a driver with two virtual images in different image distances, wherein each of the virtual images utilizes all pixels of a single image source. Linearly polarized light beams, which are emanated from the image source, pass through a dynamic polarization converter, whereby to form two image light beams with orthogonal polarization states that are switched fast for time-multiplexing. The two image light beams are selected by a polarization selection component for transmission and reflection respectively. The reflected image light beam is handled by an optical relay component to form an intermediate image. A curved mirror reflects the two image light beams to a virtual image reflecting surface to form two virtual images in different virtual image distances in respect to eyes of a driver in front of the virtual image reflecting surface.

### 1. FIELD OF THE INVENTION

The present invention relates to a head-up display system, particularly to a vehicular head-up display system with virtual images in different distances.

### 2. DESCRIPTION OF THE PRIOR ART

Many researches and applications have proved that the head-up display (HUD) device can improve driving safety. Therefore, HUD gradually becomes an essential device for vehicles where safety is emphasized. The conventional head-up display device includes an image source (such as a liquid crystal display device or a digital light processing device) and a set of optical imaging elements (such as one or more reflective mirrors or lenses), wherein the light emanated by the image source is projected to an optical combiner or the vehicle windshield to form a magnified virtual image away from the driver by a given distance. With the development of HUD, a single virtual image becomes insufficient to meet requirement. A head-up display device with at least two virtual image distances is becoming more and more preferred by drivers. The simple information, such as speed and fuel level, may be shown in a short-distance virtual image. The information needing to unite with the physical world, such as navigation information or map information, should be shown in a longer-distance virtual image. According to the ergonomic studies of HUD, the nearer virtual image should be 1.8-2.5 m away from the driver so that the driver can respond to an emergency fast; the farther virtual image should be away from the driver 7 m or more so that the image can match the external environment.

The prior arts usually use two image sources or partition an image source into two regions to generate two virtual images with different virtual image distances. The former technology is complicated in structure, high in cost, and low in durability and reliability. The latter technology sacrifices resolution, decreases the field of view, and reduces the amount of information. Therefore, the two prior-art technologies still have room to improve.

### SUMMARY OF THE INVENTION

The present invention provides a vehicular head-up display system, which uses a single image source and a time-multiplexing technology to generate two virtual images respectively in different distances, wherein different contents of all pixels of the image source are output in sequence to form different virtual images, whereby the driver perceives two virtual images appearing in different distances simultaneously.

The present invention provides a vehicular head-up display system, which uses a light polarization converter and a time-multiplexing technology to control a single image source to generate a plurality of virtual images, wherein the virtual images appear in different distances, but do not overlap, or the virtual images appear in different distances and overlap.

The vehicular head-up display system of the present invention comprises an image source, a light polarization converter, a polarization selection component, and an optical relay module. The image source is used to generate a first image light beam of a first polarization state and a second image light beam of the first polarization state according to a timing signal. The light polarization converter is disposed in the light output side of the image source and switches between a first state and a second state corresponding to the timing that the image source emanates the first image light beam and the second image light beam. In the first state, the light polarization converter converts the first or second image light beam of the first polarization state to a second polarization state. In the second state, the light polarization converter keeps the first or second image light beam being of the first polarization state. The first polarization state is orthogonal to the second polarization state. The polarization selection component is disposed at the light output side of the light polarization converter, performing transmission and reflection of the first and second image light beams, which pass through the light polarization converter, to initiate a first optical path and a second optical path. The first optical path starts from a transmitted light output side of the polarization selection component. The second optical path starts from a reflected light output side of the polarization selection component. The optical relay module establishes the first optical path and the second optical path to guide the first image light beam and the second image light beam to respectively form a first virtual image and a second virtual image. The distance from the driver to the first virtual image is different from the distance from the driver to the second virtual image. The optical relay module includes at least one optical relay planar mirror, at least one virtual image reflecting surface, and at least one curved mirror. The optical relay planar mirror is disposed in the second optical path, generating an intermediate image for the first or second image light beam in the second optical path. The virtual image reflecting surface is disposed before the field of view of the driver. The curved mirror is disposed in the first and second optical paths, reflecting the first and second image light beams of the first and second optical paths to the virtual image reflecting surface to respectively form the first virtual image and the second virtual image. The distance to the first optical path is different from the distance to the second optical path.

In a preferred embodiment, the image source may be a liquid crystal display device, an organic light-emitting diode (OLED) display device, a digital light processor, a liquid crystal-on-silicon (LCOS) display device, or a laser-scanning display (LSD) device.

In a preferred embodiment, the image source includes a linear polarizer, whereby to emanate a first image light beam of a first polarization state and a second image light beam of the first polarization state.

In a preferred embodiment, the switching frequency of the image source and the light polarization converter is not lower than 30Hz.

In a preferred embodiment, the light polarization converter includes a first twisted nematic (TN) liquid crystal unit. The first twisted nematic liquid crystal unit is disposed at the light output side of the image source. While no voltage is applied to the first twisted nematic liquid crystal unit, the first twisted nematic liquid crystal unit is in a first state. While a voltage is applied to the first twisted nematic liquid crystal unit, the first twisted nematic liquid crystal unit is in a second state.

In a preferred embodiment, the light polarization converter further includes a second twisted nematic (TN) liquid crystal unit disposed in the second optical path.

In a preferred embodiment, the polarization selection component includes a polarization beam splitter.

In a preferred embodiment, the optical relay planar mirror is a planar reflecting mirror or a transflective reflector.

In a preferred embodiment, the transflective reflector is disposed between the light polarization converter and the polarization selection component.

In a preferred embodiment, the windshield before the field of view of the driver functions as the virtual image reflecting surface.

In a preferred embodiment, an optical combiner is disposed before the field of view of the driver to function as the virtual image reflecting surface.

Below, embodiments are described in detail in cooperation with the attached drawings to make easily understood the objectives, technical contents, characteristics, and accomplishments of the present invention.

### BRIEF DESCRIPTION OF THE DRAWINGS

FIG. 1 is a side view schematically showing a vehicular head-up display system at a time point according to a first embodiment of the present invention;

FIG. 2 is a side view schematically showing a vehicular head-up display system at another time point according to the first embodiment of the present invention;

FIG. 3 is a side view schematically showing that a timing signal controls an image source to continuously output image light beams in a vehicular head-up display system according to the first embodiment of the present invention;

FIG. 4 is a side view schematically showing that a timing signal controls an image source to continuously output image light beams in a vehicular head-up display system according to a second embodiment of the present invention;

FIG. 5 is a side view schematically showing that a timing signal controls an image source to continuously output image light beams in a vehicular head-up display system according to a third embodiment of the present invention; and

FIG. 6 is a side view schematically showing that a timing signal controls an image source to continuously output image light beams in a vehicular head-up display system according to a fourth embodiment of the present invention.

### DESCRIPTION OF THE PREFERRED EMBODIMENT

The present invention will be described in detail with embodiments and attached drawings below. However, these embodiments are only to exemplify the present invention but not to limit the scope of the present invention. In addition to the embodiments described in the specification, the present invention also applies to other embodiments. Further, any modification, variation, or substitution, which can be easily made by the persons skilled in that art according to the embodiment of the present invention, is to be also included within the scope of the present invention, which is based on the claims stated below. Although many special details are provided herein to make the readers more fully understand the present invention, the present invention can still be practiced under a condition that these special details are partially or completely omitted. Besides, the elements or steps, which are well known by the persons skilled in the art, are not described herein lest the present invention be limited unnecessarily. Similar or identical elements are denoted with similar or identical symbols in the drawings. It should be noted: the drawings are only to depict the present invention schematically but not to show the real dimensions or quantities of the present invention. Besides, matterless details are not necessarily depicted in the drawings to achieve conciseness of the drawings.

The image source mentioned thereinafter is a display device able to function as a planar light source. The image source may be but is not limited to be a liquid crystal display device, an organic light-emitting diode (OLED) display device, a digital light processor (DLP), a liquid crystal-on-silicon (LCOS) display device, or a laser-scanning display (LSD) device. The image source emanates a linearly-polarized image light beam or a circularly-polarized image light beam. Alternatively, a linear polarizer is attached onto the light output surface of the image source to emanate linearly-polarized image light beams. Besides, the hardware of the image source has a given number of pixels.

The light polarization converter mentioned thereinafter may be controlled to temporarily vary the state or structure thereof, whereby to change or keep the state of the polarized image light beams. For example, the arrangement of the liquid crystal molecules of a twisted nematic liquid crystal (TN-LC) unit correlates with applied voltage. While no voltage is applied to the TN-LC unit, the TN-LC unit is in a first state. While a polarized image light beam passes through a TN-LC unit in the first state, the polarization state is rotated for 90 degrees. While a voltage is applied to the TN-LC unit, the TN-LC unit is in a second state. While a polarized image light beam passes through a TN-LC unit in the second state, the polarization state remains the same. However, the present invention does not limit that the light polarization converter must be a TN-LC unit. Besides, the switching frequency of the state or structure of the light polarization converter must be fast sufficiently, such as higher than 30 Hz.

The polarization selection component mentioned thereinafter selectively allows the polarized light beams of different polarization states to transmit, reflect, or deflect. For example, the polarization selection component let a P-polarized light beam have a transmission rate greater than 90%, as well as let the S-polarized light beam has a reflection rate greater than 80%, or let the left and right circularly polarized light beams respectively have different deflection angles. In one embodiment, the polarization selection component includes one or more polarization beam splitters (PBS), one or more Pancharatnam-Berry elements, or one or more metalenses.

The time-multiplexing technology mentioned thereinafter is using a timing signal to control the image source and the light polarization converter to have different outputs or performances in different time points.

In order to exempt the observer from perceiving flickering or seeing different contents of an image at the same time, the frequency of the timing signal had better exceed 30 Hz, preferably 60 Hz.

The optical relay module mentioned thereinafter may include one or more planar reflecting mirrors, one or more curved reflecting mirrors, one or more reflecting surfaces, and/or one or more transflective reflector. In the embodiment that the optical relay module is a reflective surface or a transmission surface, a portion of the vehicle body may function as the reflective surface or the transmission surface. For example, a portion of the windshield may function as the reflective surface or the transmission surface. Besides, another optical element may also be used as a portion of the optical relay module, such as the abovementioned TN-LC unit.

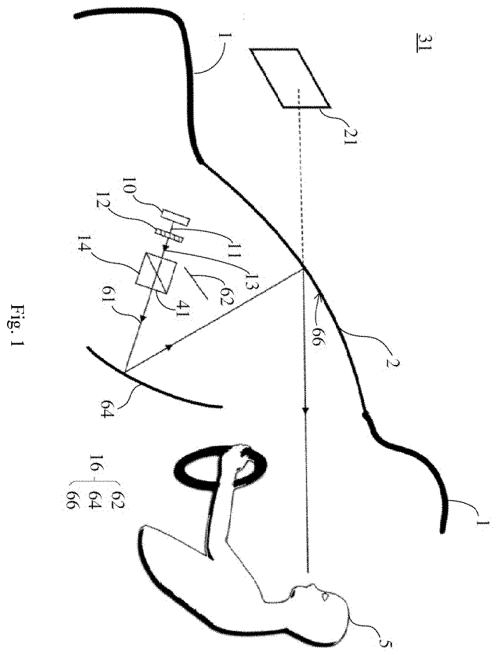

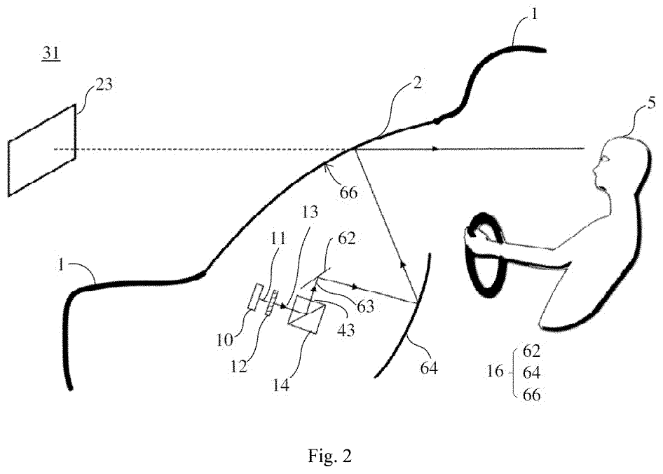

FIG. 1 and FIG. 2 are side views schematically showing a vehicular head-up display system according to a first embodiment of the present invention. In the first embodiment shown in FIG. 1 and FIG. 2, the vehicular head-up display system 31 comprises an image source 10, a light polarization converter 12, a polarization selection component 14, and an optical relay module 16. The image source 10 has a given number of pixels and outputs at least one image light beam 11 of a first polarization state. The light polarization converter 12 is disposed at the light output side of the image source 10, receiving the image light beam 11 of the first polarization state. The light polarization converter 12 undertakes switching activities to output an image light beam 13 of the first polarization state or a second polarization state. The first polarization state is orthogonal to the second polarization state. The polarization selection component 14 is disposed at the light output side of the light polarization converter 12, receiving the incidence of the image light beam 13 and determining whether the image light beam 13 starts the succeeding optical path from a first light output surface or a second light output surface. The first light output surface is different from the second light output surface. If the image light beam 13 is of the first polarization state, the polarization selection component 14 lets the image light beam 13 start the optical path from the first light output surface. For example, the image light beam 13 emanates from a transmitted light output surface 41 and propagates along a first optical path 61, as shown in FIG. 1. If the image light beam 13 is of the second polarization state, the polarization selection component 14 reflects the image light beam 13 and lets the image light beam 13 emanate from the second light output surface, such as a reflected light output surface 43, and propagate along a second optical path 63, as shown in FIG. 2. The “first” and “second” of the first optical path 61 and the second optical path 62 do not imply priority or superiority but are only to distinguish one from another. Therefore, we may alternatively describe the same fact as follows: the image light beam 13 of the second polarization state propagates along the first optical path 61, and the image light beam 13 of the first polarization state propagates along the second optical path 63. The optical relay module 16 includes several optical components. For example, a first reflecting mirror 62, a second reflecting mirror 64, and a third reflecting surface 66 are disposed in the first optical path 61 and/or the second optical path 63. Some optical components are shared by a plurality of optical paths. For example, the second reflecting mirror 64 and the third reflecting surface 66 are shared by the first optical path 61 and the second optical path 63. Some optical components are only used by a single optical path. For example, the first reflecting mirror 62 is only used in the second optical path 63. The optical components of the optical relay module 16 may be disposed in appropriate positions or a windshield 2 of a vehicle 1, or integrated with the windshield 2. The image light beam 13 of the first polarization state is processed in the first optical path 61 to form a first virtual image 21. The image light beam 13 of the second polarization state is processed in the second optical path 63 to form a second virtual image 23. The “first” and “second” of the first virtual image 21 and the second virtual image 23 do not imply priority or superiority but are only to distinguish one from another. The distance of the first optical path 61 is different from the distance of the second optical path 63. For a driver 5, the distance from the first virtual image 21 to the driver 5 is different from the distance from the second virtual image 23 to the driver 5.

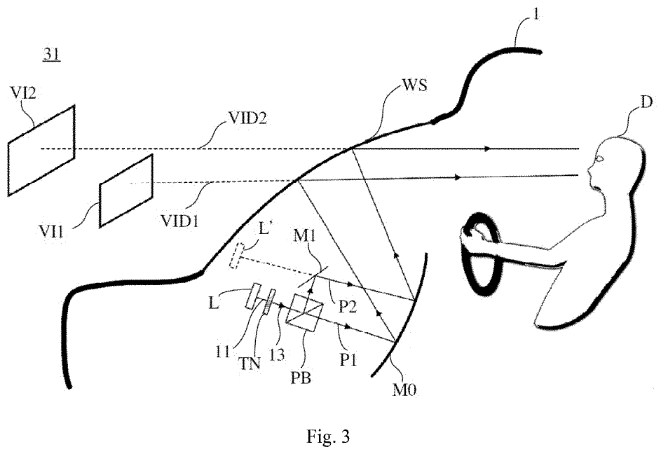

FIG. 3 is a side view schematically showing that a timing signal controls an image source to output image light beams in a vehicular head-up display system according to the first embodiment of the present invention. Refer to FIGS. 1-3. In the embodiment, the image source is a liquid crystal display device (denoted by “L” in FIG. 3) whose diagonal is 1.8 inches in length. According to a preset timing signal, the liquid crystal display device emanates an image light beam of the first polarization state, which is an S-polarized light beam with respect to the plane of the paper. The image source switches fast to emanate the first image light beam and the second image light beam in a frequency of 30 Hz or more. It should be explained: the first image light beam and the second image light beam are of the same polarization state (the S-polarized light beams). The contents of the first image light beam and the second image light beam are provided by the entire pixels of the liquid crystal display device L. The contents of the first image light beam may be different from the contents of the second image light beam. For example, the first image light beam carries the information of the instrument panel; the second image light beam carries the information of roads. However, the present invention is not limited by the abovementioned example. The polarization converter, which is at the light output side of the image source, includes a twisted nematic liquid crystal unit TN. Whether voltage is applied to the twisted nematic liquid crystal unit TN correlates with the state of the twisted nematic liquid crystal unit TN. While no voltage is applied to the twisted nematic liquid crystal unit TN, the twisted nematic liquid crystal unit TN is in a first state, converting the received image light beam 11 into a P-polarized light beam and outputting it. While a voltage is applied to the twisted nematic liquid crystal unit TN, the twisted nematic liquid crystal unit TN is in a second state, converting the received image light beam 11 into an S-polarized light beam and outputting it. If the application of voltage is switched on or off according to the same timing signal set for the image source, the first state and second state of the light polarization converter will be switched about in the same timing set for the image source. Thus, the image light beam 13 output by the light polarization converter will be the P-polarized first image light beam and the S-polarized image light beam, which are switched fast. Therefore, an identical controller may be used to synchronously control the switching timing and the switching frequency of the image source 10 and the light polarization converter 12 (TN). In other words, the light polarization converter 12 (TN) synchronously switches the first and second states thereof in response to the first image light beam and the second image light beam, which are fast switched by the image source 10.

Refer to FIGS. 1-3 again. In the first embodiment, the polarization selection component includes a polarization beam splitter PB. The polarization beam splitter PB is disposed in the propagation path of the image light beam 13 and receives the incident image light beam 13. The first reflecting mirror is a planar mirror M1. The second reflecting mirror is a non-rotationally symmetric curved mirror M0. A portion of a windshield WS is used as the third reflecting surface. While voltage is not applied to the twisted nematic liquid crystal unit TN, the P-polarized first image light beam travels along the original optical path and passes through the first light output surface of the polarization beam splitter PB to form a first image light beam P1. The first image light beam P1 continues to travel along the original optical path (a first direction), reflected by the non-rotationally symmetric curved mirror M0 and the windshield WS in sequence, entering the eyes of a driver D, and then forming a first virtual image VI1 in the direction of a sight line of the driver D, wherein the distance of the first virtual image VI1 to the driver D is a first virtual image distance VID1. While a voltage is applied to the light polarization converter 12 (TN), the S-polarized first image light beam travels along the original optical path, entering the polarization selection component 14 (PB), is reflected by the polarization selection component 14 (PB) to emanate from the second light output surface of the polarization selection component 14 (PB) to form a second image light beam P2. The second image light beam P2 continues to travel along the original optical path (a second direction), reflected by the planar mirror M1 (an optical relay planar mirror) to form an intermediate image L′. The intermediate image L′ is reflected by the non-rotationally symmetric curved mirror M0 and the windshield WS (the reflecting surfaces of virtual images), entering the eyes of the driver D, and then forming a second virtual image VI2 in the direction of a sight line of the driver D, wherein the distance of the second virtual image VI2 to the driver D is a second virtual image distance VID2. The non-rotationally symmetric curved mirror M0 (a curved reflecting mirror) is a primary element providing imaging diopter for the system, typically having a non-rotationally symmetric surface to counterbalance different aberrations in the horizontal direction and the vertical direction. It is easily understood: a plurality of curved mirrors may replace a single curved mirror to provide higher flexibility of eliminating aberration. Besides, appropriate planar mirrors may be used to adjust the positions of the optical mechanisms.

Refer to FIGS. 1-3 again. Both the liquid crystal display device L and the intermediate image L′ are inside the focus of the non-rotationally symmetric curved mirror M0. Because of the action of the optical relay of the planar mirror M1 (an optical relay planar mirror), the object distance of the intermediate image L′ is longer than the object distance of the liquid crystal display device L. Therefore, the second virtual image distance VID2 is longer than the first virtual image distance VID1. Thus, the driver D can simultaneously view the first virtual image VI1 and the second virtual image VI2. Each of the first virtual image VI1 and the second virtual image VI2 is the virtual image generated by the entire pixels of the liquid crystal display device L. The first virtual image VI1 and the second virtual image VI2 respectively have different distances, and the vision fields thereof do not overlap.

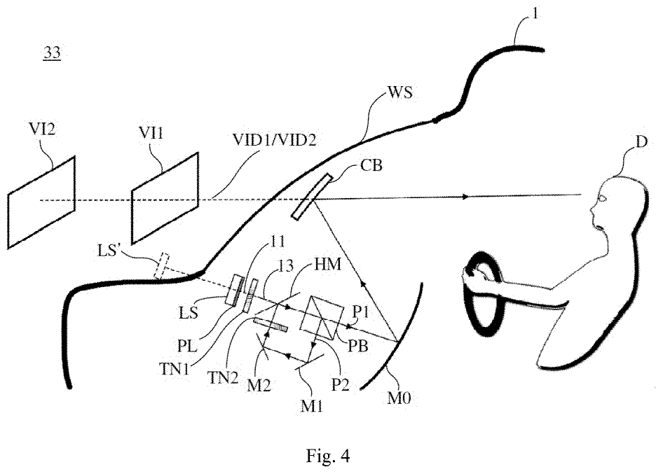

FIG. 4 is a side view schematically showing that a timing signal controls an image source to output image light beams in a vehicular head-up display system according to a second embodiment of the present invention. In the vehicular head-up display system 33, the image source is a laser scanning display device (denoted by “LS” in FIG. 4) whose diagonal is 3 inches in length. The laser scanning display device LS switches fast to emanate the first image light beam and the second image light beam in a frequency of 30 Hz or more. In the embodiment, the image source further includes a linear polarizer PL, which is attached to the light output surface of the laser scanning display device LS. The polarizing direction of the linear polarizer is S with respect to the plane of the paper. Both the first image light beam and the second image light beam, which are emanated from the image source according to a timing signal, are S-polarized mage light beams 11. Similarly to the first embodiment, the light polarization converter includes a twisted nematic liquid crystal unit TN1. According to the timing signal of the laser scanning display device LS, while no voltage is applied to the twisted nematic liquid crystal unit TN1, the twisted nematic liquid crystal unit TN1 is in a first state, receiving the image light beam 11 (the first image light beam) and converting the polarization state of the image light beam 11 to output a P-polarized image light beam 13. According to the timing signal of the laser scanning display device LS, while a voltage is applied to the twisted nematic liquid crystal unit TN1, the twisted nematic liquid crystal unit TN1 is in a second state, receiving the image light beam 11 (the second image light beam) and keeps the polarization state of the image light beam 11 to output an S-polarized image light beam 13.

Refer to FIG. 4 again. The polarization selection component and a portion of the optical relay module are disposed along the traveling direction of the image light beam 13. In the embodiment, the polarization selection component includes a polarization beam splitter PB; the optical relay module includes a transflective reflector HM disposed between the twisted nematic liquid crystal unit TN1 and the polarization beam splitter PB. The optical relay module further includes a non-rotationally symmetric curved mirror M0, a planar mirror M1, a planar mirror M2, and an optical combiner CB. The optical combiner CB is disposed inside the vehicle body and near the windshield WS, providing a reflecting surface for virtual images. Besides, the light polarization converter further includes another twisted nematic liquid crystal unit TN2, which is disposed between the planar mirror M2 and the transflective reflector HM. The twisted nematic liquid crystal unit TN2, which is positioned among the optical relay module, is constantly under no voltage.

While the twisted nematic liquid crystal unit TN1 is under no voltage and in the first state, a portion of the P-polarized image light beam 13 passes through the transflective reflector HM and the polarization beam splitter PB to generate the first image light beam P1 in the first optical path. The first image light beam P1 is reflected by the curved mirror M0 and the optical combiner CB in sequence to enter the eyes of the driver D and form the first virtual image VI1 in the direction of a sight line of the driver D. The distance from the first virtual image VI1 to the driver D is a first virtual image distance VID1. While the twisted nematic liquid crystal unit TN1 is under a voltage and in the second state, a portion of the S-polarized second image light beam 13 passes through the transflective reflector HM, reflected by the mirror of the polarization beam splitter PB to generate the second image light beam P2. In the second optical path, the second image light beam P2 is in sequence reflected by the planar mirror M1 and the planar mirror M2, which are disposed in appropriate positions. The twisted nematic liquid crystal unit TN2 constantly under no voltage is disposed in a position succeeding to the planar mirror M2 and in the optical path of the second image light beam P2. The unbiased twisted nematic liquid crystal unit TN2 rotates the polarization state of the S-polarized second image light beam P2 by 90 degrees. Thus, the twisted nematic liquid crystal unit TN2 constantly under no voltage converts the S-polarized second image light beam P2 into the P-polarized second image light beam P2. Next, the P-polarized second image light beam P2 is reflected by the transflective reflector HM to form an intermediate image LS′. Next, the intermediate image LS′ of the second image light beam P2 passes through the polarization beam splitter PB, reflected by the curved mirror M0 and the optical combiner CB in sequence to enter the eyes of the driver D and form a second virtual image VI2 in the direction of a sight line of the driver D. The distance from the second virtual image VI2 to the driver D is a second virtual image distance VID2.

Refer to FIG. 4 again. Both the laser scanning display device LS and the intermediate image LS' are inside the focus of the curved mirror M0. Further, because of the three reflection actions of the planar mirror M1, the planar mirror M2 and the transflective reflector HM, the distance of the intermediate image LS′ is longer than the object distance of the laser scanning display device LS. Therefore, the distance of the second virtual image VI2 is longer than the distance of the first virtual image VI1 . Thus, the driver D can simultaneously view the first virtual image VI1 (the contents of the first image light beam) and the second virtual image VI2 (the contents of the second image light beam). In the second embodiment, the whole pixels of the laser scanning display device LS generate in different distances two virtual images whose fields of view overlap. In comparison with the first embodiment, the overlapping of two virtual images appearing in different distances of the second embodiment may be applied to the scenarios where the contents of the far virtual image need to overlap the contents of the near virtual image.

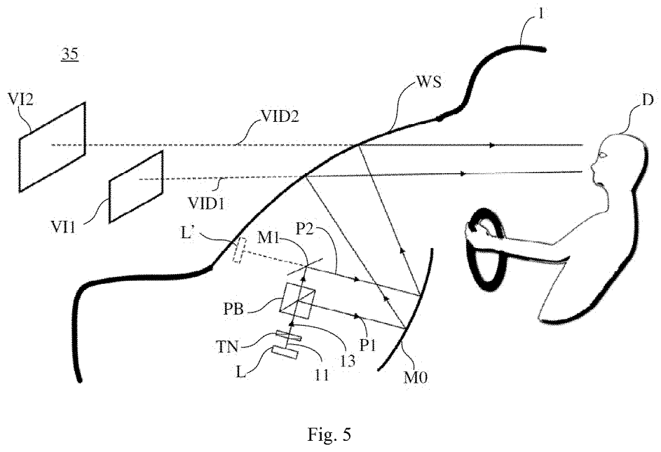

FIG. 5 is a side view schematically showing that a timing signal controls an image source to output image light beams in a vehicular head-up display system according to a third embodiment of the present invention. Refer to FIG. 3 and FIG. 5. The vehicular head-up display system 35 of FIG. 5 is different from the vehicular head-up display system 31 of FIG. 3 in the polarization states of the first image light beam and the second image light beam while they pass through the light polarization converter and in the positions of the optical elements of the optical relay module. In FIG. 5, according to the timing signal of the liquid crystal display device L, the S-polarized image light beam 11 passes through the twisted nematic liquid crystal unit TN and generates in sequence an S-polarized first image light beam P1 and a P-polarized second image light beam P2. The S-polarized first image light beam P1 is reflected firstly by the mirror of the polarization beam splitter PB, next by the non-rotation symmetric curved mirror M0, and next by the windshield WS, then entering the eyes of the driver D to form a first virtual image VI1 in the direction of a sight line of the driver D. The distance of the first virtual image VI1 to the driver D is a first virtual image distance VID1. The P-polarized second image light beam P2 passes through the polarization beam splitter PB along the original direction, next reflected by the planar mirror M1 to form an intermediate image L′. The intermediate image L′ is reflected by the curved mirror M0 and the windshield WS, then entering the eyes of the driver D to form a second virtual image VI2 in the direction of a sight line of the driver D. The distance of the second virtual image VI2 to the driver D is a second virtual image distance VID2. The third embodiment is similar to the first embodiment in the following aspects: the liquid crystal display device L and the intermediate image L′ are inside the focus of the curved mirror M0; the optical relay of the planar mirror M1 makes the distance of the intermediate image L′ longer than the object distance of the liquid crystal display device L. Therefore, the second virtual image distance VID2 is longer than the first virtual image distance VID1. Thereby, the driver D can simultaneously view the first virtual image VI1 and the second virtual image VI2, wherein the entire pixels of the liquid crystal display device L generate in different distances the first virtual image VI1 and the second virtual image VI2 whose fields of view do not overlap. The third embodiment is different from the first embodiment in that the S-polarized light beam reflected by the polarization beam splitter PB is used to generate the nearer first virtual image VI1 and the P-polarized light beam passing through the polarization beam splitter PB is used to generate the farther second virtual image VI2.

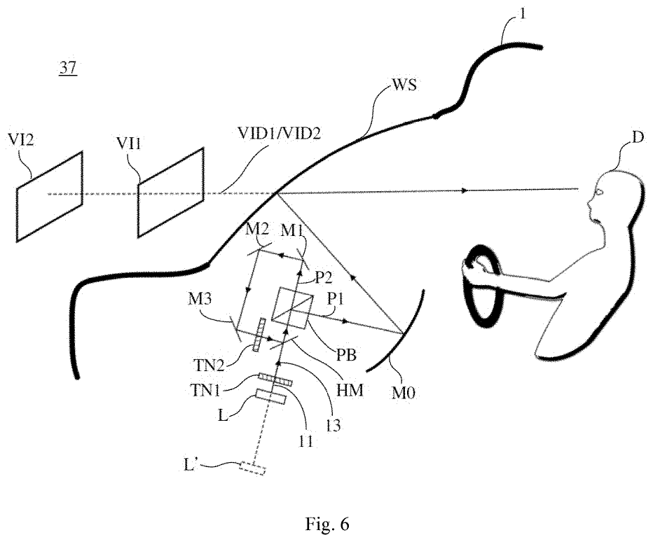

FIG. 6 is a side view schematically showing that a timing signal controls an image source to output image light beams in a vehicular head-up display system according to a fourth embodiment of the present invention. In the vehicular head-up display system 37, the image source is a liquid crystal display device L whose diagonal is 1.8 inches in length. The light beam emanated by liquid crystal display device L is a light beam S-polarized with respect to the plane of the paper. The liquid crystal display device L switches fast to emanate a first image light beam and a second image light beam in a frequency of 30 Hz or more. A twisted nematic liquid crystal unit TN1 is disposed at the light output side of the liquid crystal display device L. While the twisted nematic liquid crystal unit TN1 is under a voltage and in a first state, the liquid crystal display device L emanates the first image light beam. While the twisted nematic liquid crystal unit TN1 is under no voltage and in a second state, the liquid crystal display device L emanates the second image light beam. Therefore, the twisted nematic liquid crystal unit TN1 outputs an S-polarized image light beam 13 (the first image light beam) in the first state and outputs a P-polarized image light beam 13 (the second image light beam) in the second state. A transflective reflector HM and a polarization beam splitter PB are disposed in sequence along the propagation direction of the image light beam 13. While the twisted nematic liquid crystal unit TN1 is under a voltage and in the first state, a portion of the S-polarized image light beam 13 passes through the transflective reflector HM, reflected by the mirror of the polarization beam splitter PB to form the first image light beam P1. The first image light beam P1 is reflected by the curved mirror M0 and the windshield WS to enter the eyes of the driver D and form a first virtual image VI1 in the direction of a sight line of the driver D. The distance of the first virtual image VI1 to the driver D is a first virtual image distance VID1.

Refer to FIG. 6 again. While no voltage is applied to the twisted nematic liquid crystal unit TN1 in the second state, a portion of the P-polarized image light beam 13 passes through the transflective reflector HM and the polarization beam splitter PB to form the second image light beam P2. The second image light beam P2 is reflected by the planar mirror M1, the planar mirror M2 and the planar mirror M3 in sequence. A twisted nematic liquid crystal unit TN2, which no voltage is applied to, is disposed before the planar mirror M3 and in the propagation path of the second image light beam P2. The twisted nematic liquid crystal unit TN2 rotates the polarization state of the incident light beam by 90 degrees. Thus, the twisted nematic liquid crystal unit TN2 rotates the P-polarized second image light beam P2 into an S-polarized second image light beam P2. Next, the S-polarized second image light beam P2 is reflected by the transflective reflector HM to form an intermediate image L′. Next, the intermediate image L′ is reflected by the mirror of the polarization beam splitter PB, the curved mirror M0 and the windshield WS in sequence and then enters the eyes of the driver D to form a second virtual image VI2 in the direction of a sight line of the driver D. The distance of the second virtual image VI2 to the driver D is a second virtual image distance VID2.

Refer to FIG. 6 again. The fourth embodiment is similar to the second embodiment in the following aspects: the liquid crystal display device L and the intermediate image L′ are inside the focus of the curved mirror M0; the optical relay of the planar mirror M1, the planar mirror M2, the planar mirror M3 and the transflective reflector HM makes the distance of the intermediate image L′ longer than the object distance of the liquid crystal display device L. Therefore, the second virtual image distance VID2 is longer than the first virtual image distance VID1. Thereby, the driver D can simultaneously view the first virtual image VI1 and the second virtual image VI2, wherein the entire pixels of the liquid crystal display device L generate in different distances the first virtual image VI1 and the second virtual image VI2 whose fields of view overlap. The fourth embodiment is different from the second embodiment in that the S-polarized light beam reflected by the polarization beam splitter PB is used to generate the nearer first virtual image VI1 and the P-polarized light beam passing through the polarization beam splitter PB is used to generate the farther second virtual image V12.

The embodiments described above are to demonstrate the technical thoughts and characteristics of the present invention and enable the persons skilled in the art to understand, make, and use the present invention. However, these embodiments are not intended to limit the scope of the present invention. Any equivalent modification or variation according to the spirit of the present invention is to be also included by the scope of the present invention.

What is claimed is:

1. A vehicular head-up display system, comprising
an image source, switching to generate a first image light beam of a first polarization state and a second image light beam of the first polarization state according to a timing signal;
a light polarization converter, disposed at a light output side of the image source, switching between a first sate and a second state synchronously corresponding to that the image source switches to generate the first image light beam and the second image light beam, wherein in the first state, the light polarization converter converts the first image light beam of the first polarization state or the second image light beam of the first polarization state into the first image light beam of a second polarization state or the second image light beam of the second polarization state; in the second state, the light polarization converter keeps the first image light beam of the first polarization state or the second image light beam of the first polarization state being of the first polarization; the first polarization state is different from the second polarization state;
a polarization selection component, disposed at a light output side of the light polarization converter, enabling transmission and reflection of the first image light beam and the second image light beam, which have passed through the light polarization converter, to initiate a first optical path and a second optical path, wherein the first optical path starts from a transmitted light output surface of the polarization selection component, and the second optical path starts from a reflected light output surface of the polarization selection component; and
an optical relay module, disposed in the first optical path and the second optical path to guide the first image light beam and the second light beam to respectively form a first virtual image and a second virtual image, wherein a distance of the first virtual image to a driver is different from a distance of the second virtual image to the driver; the optical relay module includes
at least one optical relay planar mirror, disposed in the second optical path, and using the first image light beam or the second image light beam, which are in the second optical path, to generate an intermediate image;
a virtual image reflecting surface, disposed before a view field of the driver; and
a curved mirror, disposed in the first optical path and the second optical path, reflecting the first image light beam and the second image light beam in the first optical path and the second optical path onto the virtual image reflecting surface to form the first virtual image and the second virtual image, wherein a distance of the first optical path is different from a distance of the second optical path.

2. The vehicular head-up display system according to claim 1, wherein the image source is a liquid crystal display device, an organic light-emitting diode (OLED) display device, a digital light processor (DLP), a liquid crystal-on-silicon (LCOS) display device, or a laser-scanning display (LSD) device.

3. The vehicular head-up display system according to claim 2, wherein the image source further includes a linear polarizer used to emanate the first image light beam of the first polarization state and the second image light beam of the first polarization state.

4. The vehicular head-up display system according to claim 1, wherein a switching frequency of the image source and the light polarization converter is not lower than 30Hz.

5. The vehicular head-up display system according to claim 1, wherein the light polarization converter includes a first twisted nematic liquid crystal unit disposed at the light output side of the image source; while no voltage is applied to the first twisted nematic liquid crystal unit, the first twisted nematic liquid crystal unit is in the first state; while a voltage is applied to the first twisted nematic liquid crystal unit, the first twisted nematic liquid crystal unit is in the second state.

6. The vehicular head-up display system according to claim 5, wherein the light polarization converter includes a second twisted nematic liquid crystal unit disposed in the second optical path.

7. The vehicular head-up display system according to claim 1, wherein the polarization selection component includes a polarization beam splitter.

8. The vehicular head-up display system according to claim 1, wherein the optical relay planar mirror is a planar mirror or a transflective reflector.

9. The vehicular head-up display system according to claim 8, wherein the transflective reflector is disposed between the light polarization converter and the polarization selection component.

10. The vehicular head-up display system according to claim 1, wherein the virtual image reflecting surface is provided by a windshield before the view field of the driver.

11. The vehicular head-up display system according to claim 1, wherein the virtual image reflecting surface is provided by an optical combiner disposed before the view field of the driver.
